(19) United States
(12) Patent Application Publication
(10) Pub. No.: US 2005/0082326 A1
(43) Pub. Date: Apr. 21, 2005

(54) Multi-purpose storage rack for a sport utility vehicle

(76) Inventor: Paul Badillo, Littleton, CO (US)

Correspondence Address: SHERIDAN ROSS PC, 1560 BROADWAY, SUITE 1200, DENVER, CO, 80202, US

(21) Appl. No.: 10/948,972

(22) Filed: Sep. 24, 2004

Related U.S. Application Data
(63) Continuation-in-part of application No. 29/177,928, filed on Mar. 17, 2003.
(63) Continuation-in-part of application No. 29/183,072, filed on Jun. 4, 2003.
(60) Provisional application No. 60/506,496, filed on Sep. 26, 2003.

(51) Int. Cl. B62D 43/00; B60R 9/00; B60R 9/055

(52) U.S. Cl. 224/326; 224/42.13

(57) ABSTRACT

A storage rack is provided that is adapted for interconnection with the roof of a sports utility vehicle. More specifically, the present invention consists of a lower support structure and an upper support structure separated by a plurality of vertical supports, wherein the lower support structure traverses the width of the roof and is adapted to support luggage or other items. In addition, one embodiment of the present invention includes a novel tire storage area wherein a spare tire of the vehicle may be stowed and easily removed based on a distinct geometry.

This application claims the benefit of U.S. Provisional Patent Application Ser. No. 60/506,496, filed Sep. 26, 2003, and is a Continuation-in-Part of pending U.S. Design patent application Ser. No. 29/177,928, filed Mar. 17, 2003 and Ser. No. 29/183,072, filed Jun. 4, 2003, each application being incorporated herein by reference in their entirety.

### FIELD OF THE INVENTION

The present invention is related to storage and spare tire racks that are adapted for interconnection to the roof of a sport utility vehicle (hereinafter “SUV”) or other type of automobile.

### BACKGROUND OF THE INVENTION

Racks are generally used as a means to provide additional storage space on motor vehicles. Generally, the rack is interconnected to the roof or hood of a vehicle, thus providing area for additional storage. Moreover, the space provided by racks allows the area inside the vehicle to be used for additional storage or passenger seating.

With the relatively recent explosion of SUV popularity it has become apparent that a more versatile rack is needed to accommodate the active lifestyle of vehicle owners. For example, the HUMMER® SUV, which is the civilian version of the United States military's Hum-V, has become very popular. However, one drawback of the HUMMER®, and many other SUVs, is that they have limited internal storage space, and are generally not equipped with a storage rack. Although storage “bars” which traverse the width of the roof are often provided by the manufacturer, the bars are adapted to interface with bike or ski racks, for example, and are not well suited to carry luggage. Thus, passenger luggage must be stored in the main cabin of the vehicle such that passenger seating area is drastically reduced.

Another drawback of SUVs is the storage of the spare tire. Often, SUVs are provided with a full spare, which is stored under the rear of the vehicle, on the rear door of the vehicle, or inside the vehicle's rear compartment. Storing the spare tire under the vehicle is not ideal because of increased probably of spare tire damage during normal vehicle use. In addition, the ground clearance is reduced in the vicinity of the spare tire, thus possibly causing interference problems upon ascending or descending a sloped surface. Further, the removal operation of the tire from its storage location is more difficult. Storage of the wheel on the rear portion of the vehicle is also problematic since the tire reduces visibility, adds difficulty in opening the door, and increases the length of the vehicle which makes parking in some areas difficult. Studies have also shown that rear impact damage in the vicinity of the rear-mounted spare tire is significantly increased, thus increasing the probability of injury to the driver of the impacting vehicle. Finally, tire storage inside the vehicle drastically reduces the inner storage capacity and exposes the passengers to potentially harmful odors from the tire rubber, and hence is not desirable.

Thus, it is a long felt need in the field of vehicle storage racks to provide a rack that is easily interconnected to an SUV, is adapted to carry objects of various shapes and sizes, and may be adapted to hold a spare tire in a location proximate to the roof of an SUV. The following disclosure describes an improved storage rack that is adapted for interconnection to a roof of an SUV and that is adapted to secure the vehicle's spare tire.

### SUMMARY OF THE INVENTION

It is one aspect of the present invention to provide a roof rack that is adapted for interconnection to an SUV. More specifically, one embodiment of the present invention interconnects with factory equipped roof structures that are found on many vehicles. Generally, roof structures consist of at least two rails that extend substantially the entire length of the roof, and a plurality of cross members that span the width of the roof, from rail to rail. For example, the OEM rack of the HUMMER®SUV consists of two long channels, constructed from rectangular tubing, that span the length of the vehicle's roof. In addition, a plurality of rectangular nut plates are provided that are adapted to slide into the channels, that provide interconnection locations for ends of the cross members. Generally, the cross members are fastened to the nut plates with screws or bolts. The cross members provide tie-down locations for luggage and interface locations wherein a bike or ski rack may be interconnected. However, it is often desirable to provide a partially enclosed, basket-type area to carry sporting equipment, building supplies, tools, etc. Thus, one embodiment of the present invention comprises a basket-type rack that further includes a plurality of brackets interconnected thereto that are adapted to selectively interconnect to nut plates located in the channels with fastening devices such as bolts, screws, or adhesives. Alternately, the rack may be rigidly interconnected to the SUV, by a welding process by the auto manufacturer or auto dealer.

Generally, the rack of the present invention includes, among other things, a frame fashioned from tubular material. More specifically, the frame consists of a substantially planar series of interconnected tubes, that further include outer primary tubes and internal cross members. An upper series of interconnected tubes, which is offset from the first, lower series of planar tubes by a plurality of vertical support members, is also included. The vertical support members dictate the height of the rack, thus the rack maybe constructed with a low profile that will reduce the occurrences of impingements with garages and car washes, for example. Mesh material is integrated on the first series of tubes to create a storage surface. Depending on the intended use, the mesh can cover all, or a portion, of the first series of tubes. More specifically, one embodiment of the present invention is provided with partial mesh coverage, such that a vehicle's sun or moon roof can be used without the view being obscured by the mesh. Alternatively, the mesh may be selectively removable from the area above the sun or moon roof. Finally, the entire rack may be constructed such that only a portion of the roof is covered, wherein the rack is interconnected to the rear of the roof, for example.

It is another aspect of the present invention to provide a rack that is equipped with a spare tire attachment area. More specifically, one embodiment of the present invention is equipped with a tire interface mechanism that is adapted for selective interconnection with a spare tire, thereby allowing the interior of the vehicle to be used more productively and making the spare tire easier to access. To disengage the tire, a user would simply remove a tire interface mechanism and slide the spare tire out of the rack and transition it to the ground, To disengage the tire, a user would simply remove a tire interface mechanism and slide the spare tire out of the rack and transition it to the ground, whereby gravity would do most of the work. Thus, less manipulation of the spare is required in order to change a tire, which lowers the probability of personal injury and increases the efficiency of the replacement operation. In addition, in a related embodiment of the present invention, the rear portion of the rack, that is the vertical support members and upper structure, are removed, thereby providing an unobstructed path for which the tires can travel.

It is still yet another aspect of the present invention to provide a storage rack that is adapted to accommodate existing tire storage devices. More specifically, some SUVs are factory equipped with roof-mounted tire storage devices, or the means to easily interface with such a device. One embodiment of the present invention provides a location wherein the existing tire storage device maybe accommodated, such as a structure-free area that provides an interference-free path between the rack and the tire storage device.

It is yet another aspect of the present invention to provide a rack that is cost effective to manufacture. One embodiment of the present invention includes a welded assembly of tubular material, such as stainless steel. One skilled in the art will appreciate that other materials are equally suited for the rack construction, such as aluminum, Inconel, plastic, iron, etc. In addition, other member interconnection mechanisms may be employed such as brazing, adhering, screwing, bolting, or any other suitable interconnecting method known in the art. Alternatively, the rack may be constructed to easily disassemble for storage. Further, the mesh portion of the rack may be constructed from preferably the same material as the tube members to allow for welding. The mesh may be made out of any of the above-mentioned materials and selectively interconnected to the tube members at predetermined locations with bolts, screws, grommets, buttons, clasps, latches, ties, etc.

It is yet another embodiment of the present invention to provide a roof rack that accommodates a plurality of lights, a wind deflector, and includes locations to receive securing straps or brackets. More specifically, one embodiment of the present invention includes electrical conductors integrated into the structure of the rack in order to provide electrical power to lights, such as fog lights. Additional electrical connectors for interconnection to speaker wires may be included that provide locations for selective interconnection to speakers that may be used during camping trips or other outings, such as tailgating before a football game. One skilled in the art will appreciate that other lights may be employed on the rack for safety or to add flair to the vehicle, such as neon or flashing lights.

Next, it is envisioned that one embodiment of the present invention equipped with a wind deflector that helps alleviate some of the undesirable aerodynamic effects that a rack of this type poses. More specifically, racks that are interconnected to roofs may cause turbulent air flow over the vehicle thereby decreasing the fuel efficiency thereof. A wind ramp integrated between the roof and the rack such that air flow is directed over and around the rack alleviates some of these effects.

Finally, another related embodiment of the present invention includes a plurality of locations where straps or brackets can be selectively interconnected. More specifically, a plurality of hook fastening locations are provided wherein bungee cords or other tie down devices, may be fastened. In addition, a plurality of brackets for serving various items may be interconnected to the rack. Thus, the present invention is envisioned to provide a plurality of attachment locations for items such as a stretcher, an axe, a shovel, a mountain bike, a motorcycle, a utility box, a tool box, a water storage container, a gas container, a raft, a kayak, a pair of skis, a snow board or a generator. In addition, one embodiment of the present invention is adapted to be used in fire and/or rescue operations, wherein a plurality of the items described above are accommodated.

It is still yet another embodiment of the present invention to provide a roof rack system that further includes a ladder. More specifically, one embodiment of the present invention is adapted to be used in conjunction with a ladder. Due to their increased ground clearance, SUVs are often extremely tall. Thus, the addition of a ladder to the present invention will allow users to easily reach the contents of the rack, and aid them in the removal of the spare tire. In one embodiment of the present invention, the ladder is shaped to match the contour of the rear of the vehicle. Preferably, the rack is selectively interconnected to the vehicle by the use of fasteners, brackets, and/or hooks, thereby providing little or no damage to the vehicle upon installation. Alternatively, the ladder is adapted to selectively interface with the rack in a plurality of locations, thus providing the user various loading and unloading areas. In addition, the ladder is preferably constructed out of the same materials that the main rack is constructed of, thus reducing costs.

Thus, it is one aspect of the present invention to provide a storage rack adapted for interconnection with the roof of a vehicle, comprising:
a lower support structure having a front member and a rear member with two side members positioned therebetween, said rear member also including an arcuate member located between said two side members and extending toward said front member;
an upper support structure of generally the same shape of said lower support structure;
a plurality of vertical members interconnecting said lower support structure to said upper support structure to define a semi-enclosed storage area;
a plurality of transverse members spanning between said two side members of said lower support structure;
a plurality of longitudinal members spanning between at least two of said plurality of transverse members; and
a spare tire support structure interconnected to said lower support structure and bounded by said arcuate member wherein a spare tire may be selectively interconnected to said storage rack such that it rests on said spare tire support structure adjacent to said arcuate member of said lower support structure and said arcuate member of upper support structure, wherein the spare tire may be selectively positioned and removed from said storage rack without lifting the spare tire over said upper support structure.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a top plan view of one embodiment of the present invention that is equipped with a spare tire storage area;

FIG. 2 is a left elevation view of the embodiment shown in FIG. 1;

FIG. 3 is a right elevation view of the embodiment shown in FIG. 1;

FIG. 4 is a front elevation view of the embodiment shown in FIG. 1;

FIG. 5 is a front perspective view of the embodiment shown in FIG. 1;

FIG. 5A are top plan views of various shapes of the tire storage areas than may be integrated into the present invention;

FIG. 6 is a perspective view of an alternative embodiment of the present invention of that shown in FIG. 1, which includes an extended mesh portion;

FIG. 7 is a front perspective view of an alternative shorter embodiment of the present invention of that shown in FIG. 1;

FIG. 7A is a front perspective view of an alternate embodiment of the present invention that is adapted to interface with an existing tire storage device;

FIG. 7B is a partial top plan view of an alternate embodiment of the present invention that is adapted to interface with an existing tire storage device;

FIG. 8A is a front perspective view of the embodiment shown in FIG. 1, which shows the attachment hardware used to interconnect the rack to an SUV;

FIG. 8B is a top plan view of a channel employed on a factory-supplied HUMMER® roof rack;

FIG. 8C is a front elevation view of the channels shown in FIG. 8B;

FIG. 8D is a perspective detail view of rectangular nut plates that interface with the rack channels and interconnect with brackets of the rack;

FIG. 8E is a left elevation view of the channel and nut plates shown in FIGS. 8B and 8C;

FIG. 8F is a top plan view of an embodiment of the present invention that employs a alternate attachment means;

FIG. 8G is a partial section view of the embodiment of the present invention shown in FIG. 8F;

FIG. 8H is a detailed view of the embodiment of the present invention shown in FIG. 8F;

FIG. 9 is a top plan view of an alternate embodiment of the present invention that omits the spare tire interface area;

FIG. 10 is a left elevation view of the embodiment shown in FIG. 9;

FIG. 11 is a right elevation view of the embodiment shown in FIG. 9;

FIG. 12 is a front elevation view of the embodiment shown in FIG. 9;

FIG. 13 is a front perspective view of the embodiment shown in FIG. 9;

FIG. 14 is a top plan view of an alternate embodiment of the present invention that omits the spare tire interface area, and which has a lower profile than the embodiment of FIG. 9;

FIG. 15 is a left elevation view of the embodiment shown in FIG. 14;

FIG. 16 is a right elevation view of the embodiment shown in FIG. 14;

FIG. 17 is a front elevation view of the embodiment shown in FIG. 14;

FIG. 18 is a front perspective view of the embodiment shown in FIG. 14;

FIG. 19 is a top plan view of an alternate embodiment of the present invention that omits the spare tire interface area, which has a lower profile than the embodiment of FIG. 9, and which incorporates additional mesh than the embodiment of FIG. 9;

FIG. 20 is a left elevation view of the embodiment shown in FIG. 19;

FIG. 21 is a right elevation view of the embodiment shown in FIG. 19;

FIG. 22 is a front elevation view of the embodiment shown in FIG. 19;

FIG. 23 is a top plan view of an alternate embodiment of the present invention that omits the spare tire interface area, which has a lower profile than the embodiment of FIG. 9, and which includes increased mesh in the forward portion of the rack;

FIG. 24 is a left elevation view of the embodiment shown in FIG. 23;

FIG. 25 is a right elevation view of the embodiment shown in FIG. 23;

FIG. 26 is a front elevation view of the embodiment shown in FIG. 23;

FIG. 27 is a front perspective view of the embodiment shown in FIG. 23;

FIG. 28 is a top plan view of an alternate embodiment of the present invention that omits the spare tire interface area, and which has a lower profile than the embodiment of FIG. 9;

FIG. 29 is a left elevation view of the embodiment shown in FIG. 28;

FIG. 30 is a right elevation view of the embodiment shown in FIG. 28;

FIG. 31 is a front elevation view of the embodiment shown in FIG. 28;

FIG. 32 is a front perspective view of an alternate embodiment of a shortened roof rack;

FIG. 33 is a front elevation view of a ladder that may be used in conjunction with a rack of the present invention;

FIG. 34 is a rear elevation view of the ladder of FIG. 33;

FIG. 35 is a right elevation view of the ladder of FIG. 34;

FIG. 36 is a front perspective view of the ladder of FIG. 35;

FIG. 36A is a partial cross section view of the ladder of FIG. 33 selectively interconnected to the rear door of an SUV;

FIG. 37 is a rear perspective view of the rack and ladder combination of one embodiment of the present invention shown selectively interconnected to an SUV;

FIG. 38 is a left elevation view of a tool bracket and associated tool attachment mechanism that may be interconnected to the rack;

FIG. 39 is a left elevation view of the tool bracket shown in FIG. 38 with tools installed; and

FIG. 40 is a front perspective view of tool bracket securing various tools.

To assist in the understanding of the present invention the following list of components and associated numbering found in the drawings is provided herein:
# Component
2 Roof rack
4 Sport utility vehicle
6 Lower structure
8 Upper structure
10 Vertical member
12 Transverse member
14 Lower structure support member
16 Mesh
18 Bracket
20 Spare tire storage area
22 Spare tire
24 Tire support arcuate member
26 Tire retention device
28 Channel
30 Transverse beam
32 Nut plate
34 Washer
36 Fastener
38 Wind deflector
40 Open area
42 Ladder
44 Upper bracket
45 Fastener
46 Beam interface bracket
48 Nut plate
50 SUV rear door
52 Door hinge
54 Tire storage device
56 Non-meshed area
58 Tool bracket
60 Knob
62 Axe support
64 Shovel support
66 Axe
68 Shovel
70 Tool retainer
72 Screw

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

### DETAILED DESCRIPTION

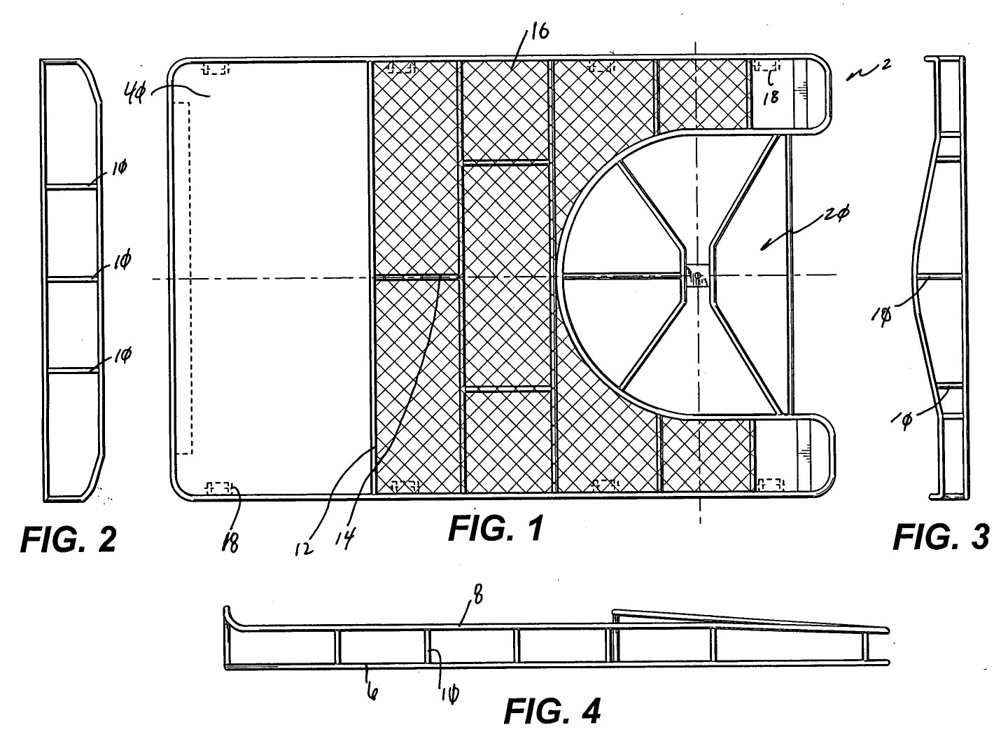

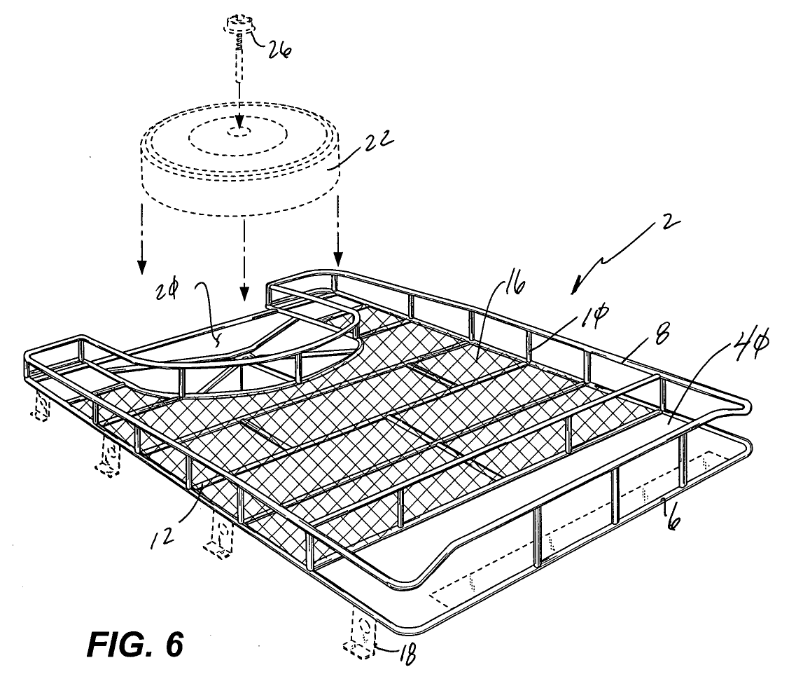

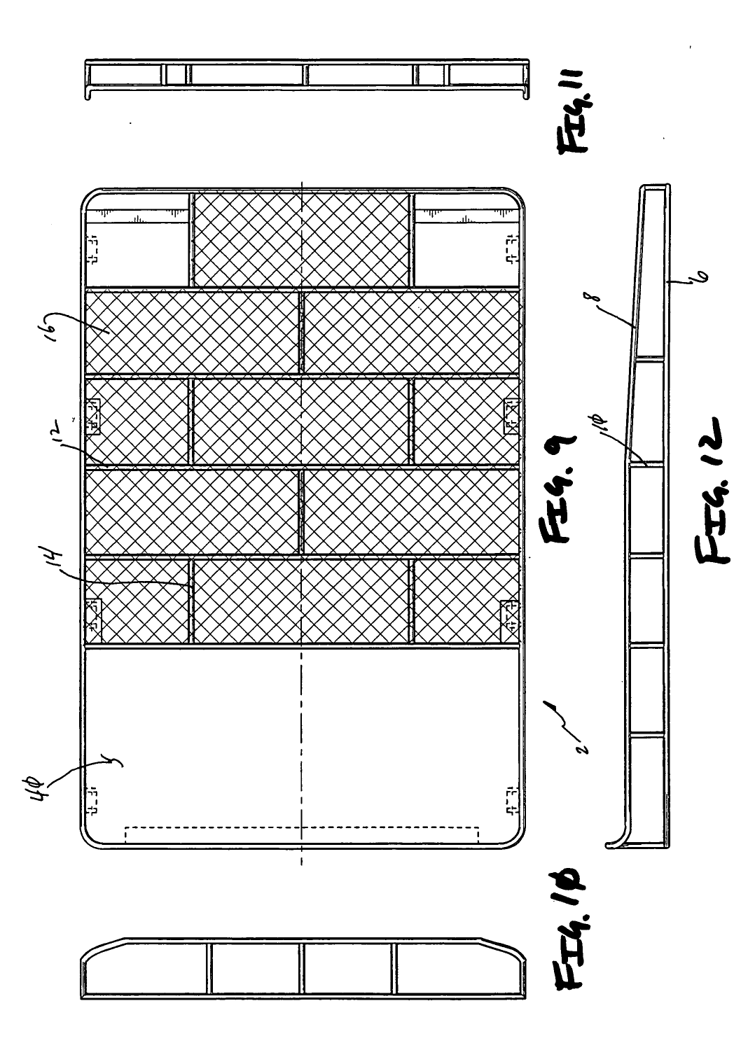

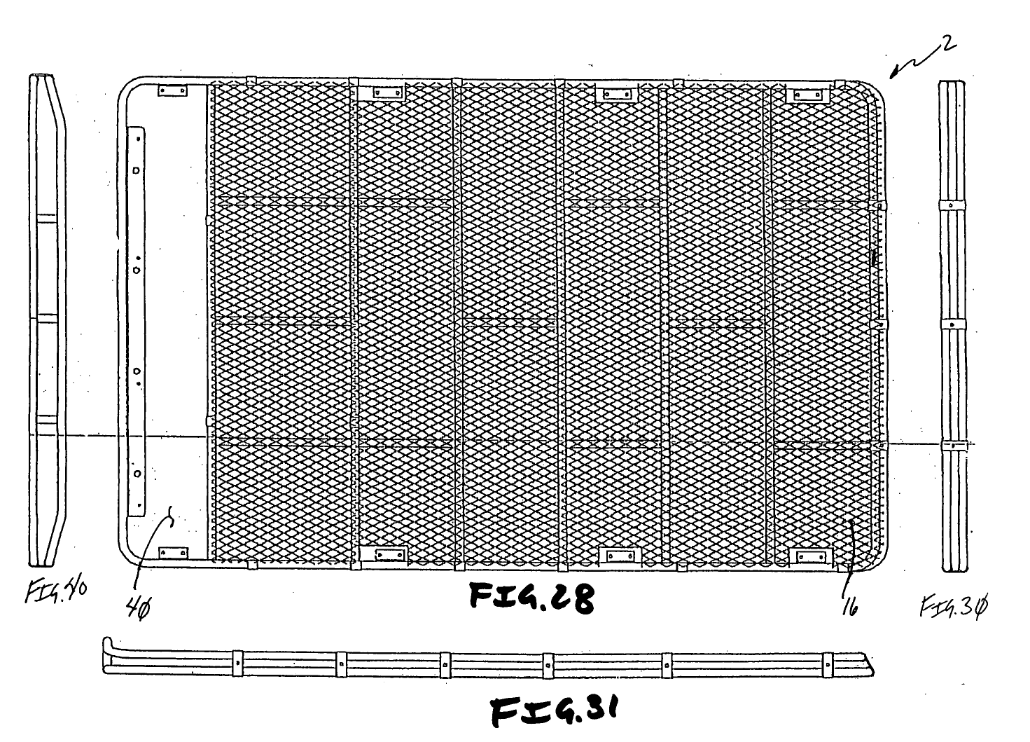

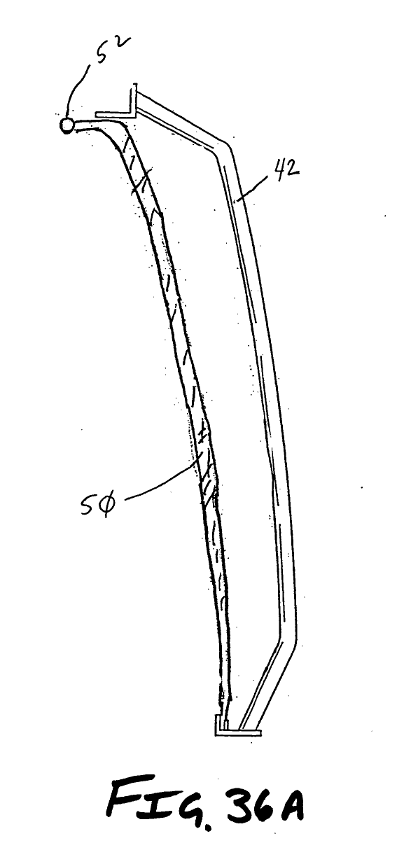

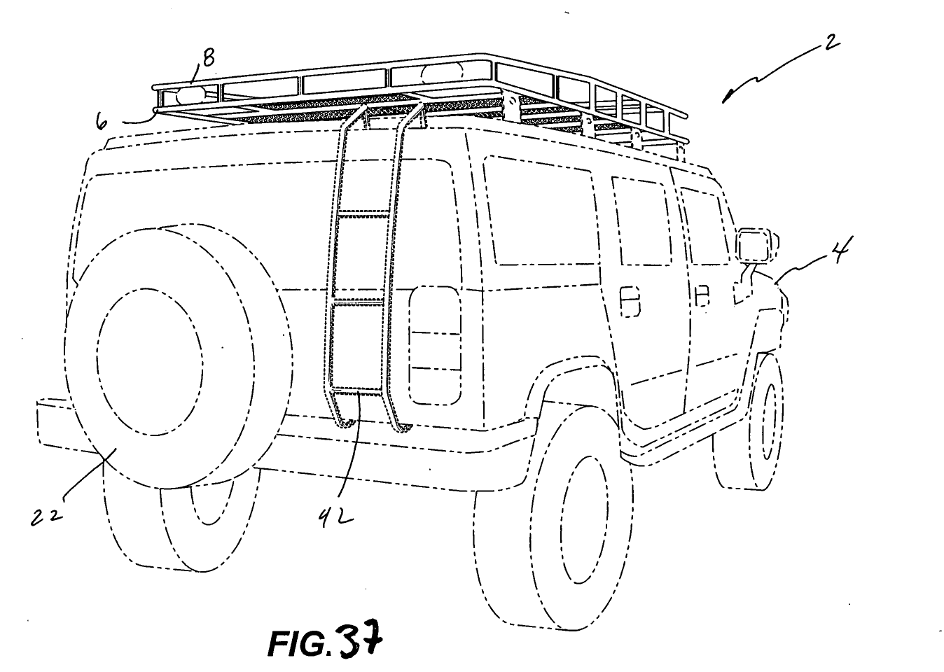

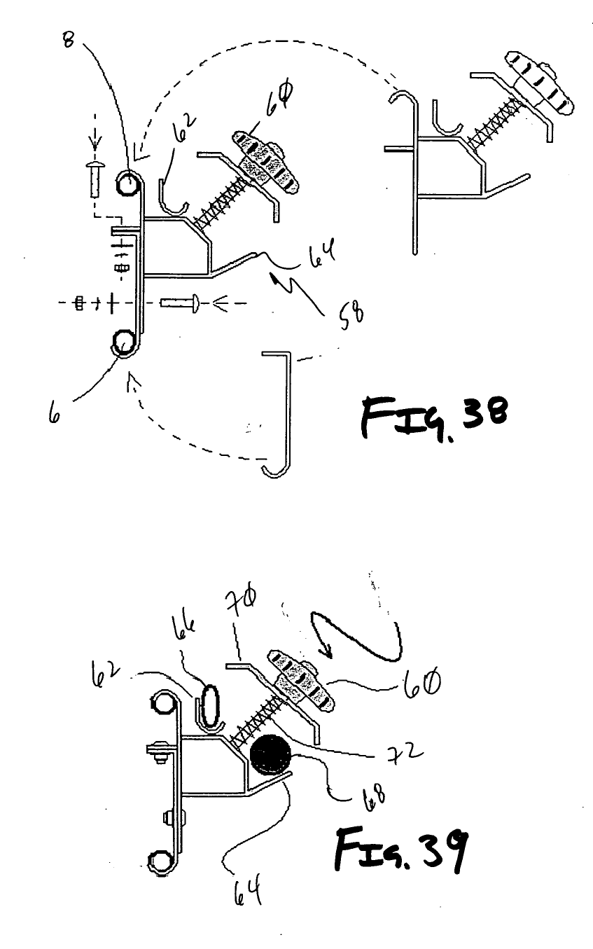

Referring now to FIGS. 1-40, a roof rack 2 adapted for interconnection with an SUV 4 is shown. More specifically, a roof rack 2 that consists of a lower structure 6 and upper structure 8 that is separated by a plurality of vertical members 10 is provided herein. The lower structure 6 is also comprised partially of transverse members 12 and other support members 14 covered by wire mesh 16 in selected areas. Generally, the members of the rack are constructed of tubular material such as steel, aluminum, Inconel, iron, etc. A plurality of brackets 18 are provided that are interconnected to predetermined locations on the lower structure 6 and which interface with structure on the SUV 4. Finally, a spare tire storage area 20 is provided on the rack 2 that receives and selectively secures a spare tire 22 of the SUV 4. This feature of one embodiment of the present invention allows the vehicle to carry additional payloads therein, because the internal area usually allocated for tire storage is now not needed. Other embodiments of the present invention will be described hereinbelow that do not include the tire storage area 20, but have other features, such as lower profile or different mesh 16 configurations.

Referring now to FIGS. 1-5, a roof rack 2 that includes tire storage area 20 is shown. More specifically, a roof rack 2 that includes a lower structure 6 and upper structure 8, separated by vertical members 10, is shown. The lower structure 6 in one embodiment is tubular in nature, arranged in a generally rectangular assembly that has dimensions approximate to the roof it is interconnected to, and which also includes a plurality of transverse members 19 that span the length of the roof of the SUV 4. In addition, various other support members 14 that span between the transverse members 12 are selectively interspersed therebetween to provide increased structural support. It will be apparent to one skilled in the art that any combination of transverse 12 and other support members 14 may be used to achieve the present invention. More specifically, the members of the lower structure 6 may be tailored to fit any load requirement, for example. The upper structure 8, in one embodiment, generally matches the shape of the lower structure 6 and is separated therefrom by a plurality of vertical members 10 of predetermined height. In one embodiment of the present invention, the vertical members 10 are of varying heights, wherein the slope of the upper structure 8 with respect to lower structure 6 decreases toward the end of the vehicle. This inclination provides easier access for the user when adding or removing items to the rack 2. More specifically, the inclination alleviates the need for a user to lift their legs very high to traverse the outer rack border when embarking or disembarking the rack 2. This feature is a major safety item, because many roof racks on SUVs, such as the HUMMER®, are often five to seven feet above the ground. An additional safety feature of another related embodiment of the present invention is the omission of vertical 10 or upper and lower structural members toward the rear of the rack. This feature allows a user to easily access the rack without having to traverse the outer border thereof. In an alternative embodiment of the present invention, the vertical members 10 selectively increase and decrease in height. This allows the relative spacing of the upper structure 8 and the lower structure 6 to be selectively changed to alter the basket depth of the rack. Alternatively, hinges may be employed in the upper 8 or lower 6 structures to allow for variable height increases and decreases of the rack 2.

The tire storage area 20 of one embodiment of the present invention, is an assembly of arcuate shaped members 24 incorporated into the upper 8 and lower 6 structure with vertical support members 10 interspersed at predetermined locations therebetween. In addition, a plurality of tubes that are designed to support the tire 12 are incorporated into the rack 2 in generally the same plane as the lower support structure 6. Preferably in one embodiment of the present invention, the tire storage area 20 is equipped with arcuate members 24 that selectively taper from the front end of the vehicle towards the rear. This feature aids in removal of the tire 22 while allowing for sufficient support thereof. In addition, the rear structure of the rack, that is the vertical members 10 proximate to the tire storage area 20 are removed, thereby allowing one to selectively reach the tire 22, disengage the holding mechanism, and easily slide the tire 22 out of the rack 2 without having to lift it over the rear structure of the rack. The tire 22 is then slid down the ladder of the vehicle, thereby alleviating much of the load that one would have to carry to disengage and move the tire 22 from the rack 2 to the ground.

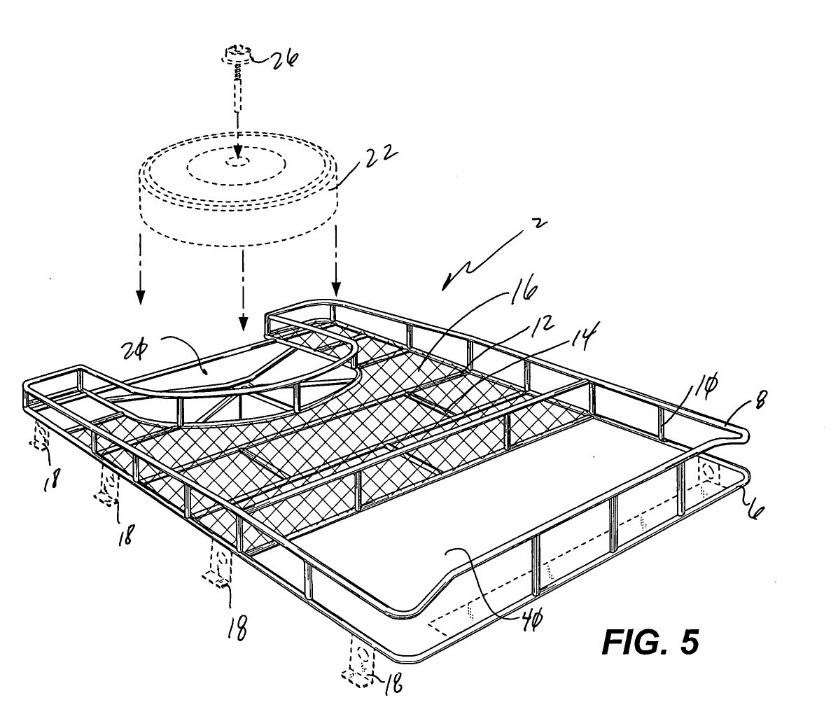

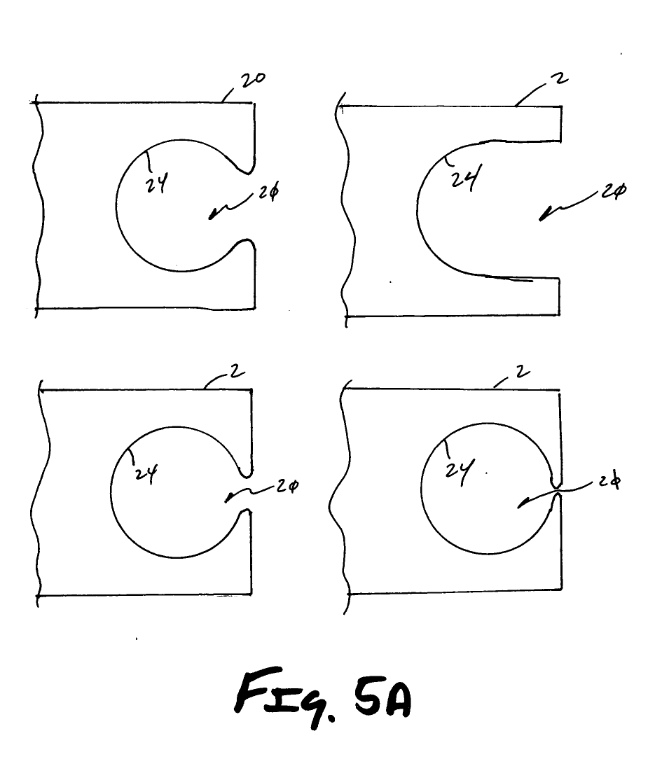

Referring now specifically to FIGS. 5-7, the selective interconnection of the tire 22 onto the roof rack 2 is shown. Generally, a user would lift a tire 22 onto the tire support area of the rack 2 wherein the tire 22 would rest on the lower support structure 6 and be separated a predetermined distance from the arcuate members 24 that approximately match the contour of the tire 22. In one embodiment of the invention, the predetermined tire-to-arcuate member distance is 1 to 5 inches, preferably 3 inches, to provide sufficient clearance to allow a larger tire to be stored, for example. Next, a tire retention device 26, for example a screw, would be inserted through an aperture in the tire 22 and selectively interconnected to a compatible fastening member on the lower support structure 6. As shown in FIG. 5A, the arcuate members 24 may surround the spare tire to varying degrees to provide increased protection from tire disengagement if the tire retention device should fail. Additional members may be used to retain the tire 22 onto the rack 2, for example, lug nuts that interface with the lug holes in the tire's wheel may be used, or a cage-like structure may be used that encompasses the tire 22 to prevent tampering and removal. Also, a locking mechanism may be employed that would reduce the probability of theft or tampering.

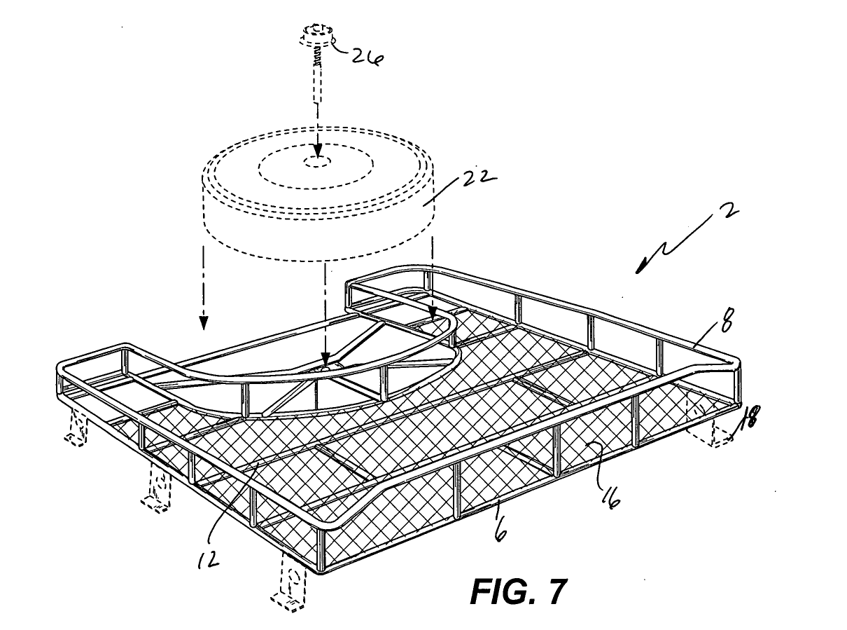

Referring now to FIGS. 7A and 7B, alternate embodiments of the storage rack 2 are shown. Some vehicle manufactures include tire storage devices 54 integrated onto the roof of an SUV 4, or alternatively, provide locations that may be adapted to receive such a device 54. Thus, one embodiment of the present invention is adapted to interface with an existing tire storage device 54. More specifically, a rack 2 is provided that includes a non-meshed area 56, which allows interference-free installation and/or removal of the rack 2 while allowing the tire storage device 54 to function as designed. Alternatively, as shown in FIG. 7B, the rack 2 may be designed to terminate in the vicinity of the tire storage device. Further, referring again to FIG. 5A, the rack may employ a plurality of various arcuate shaped members 24 that are adapted to restrain the tire if the tire storage device should fail.

As shown in FIGS. 1-7, one embodiment of the present invention is equipped with mesh 16 or grating material that covers a portion of the lower structure 6 of the rack 2. This meshed area may be tailored to fit the user's particular needs. For example, SUVs often arrive equipped with sun or moon roofs, wherein the presence of mesh 16 would obstruct airflow into the vehicle, or view out of the vehicle. Thus, one embodiment of the present invention omits the mesh 16 in an area approximate to the sun roof or moon roof of the SUV. Alternatively, the mesh may be selectively moved from one section to another of the lower structure thereby providing the user a plurality of lower structure enclosure options. In a related embodiment of the present invention, the rack 2 is manufactured shorter, wherein no part of the rack 2 would extend over the sun roof.

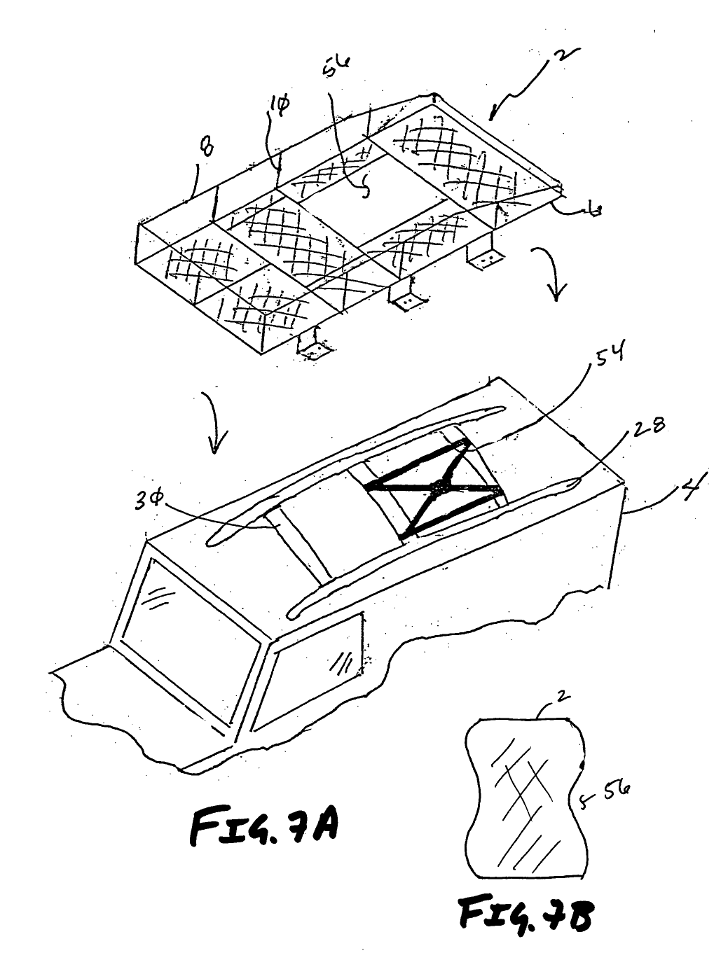

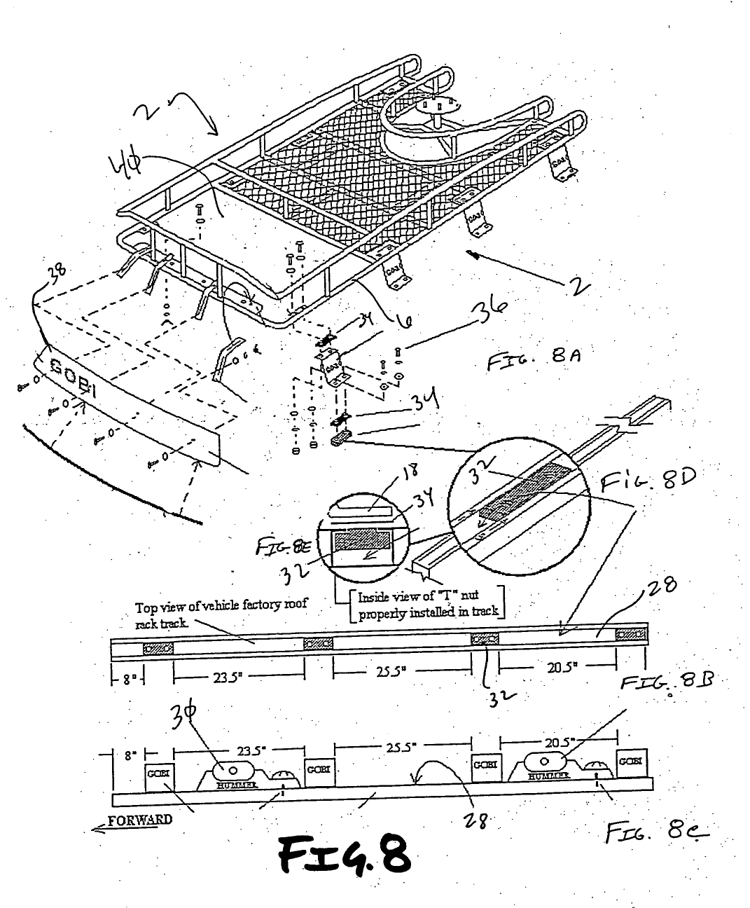

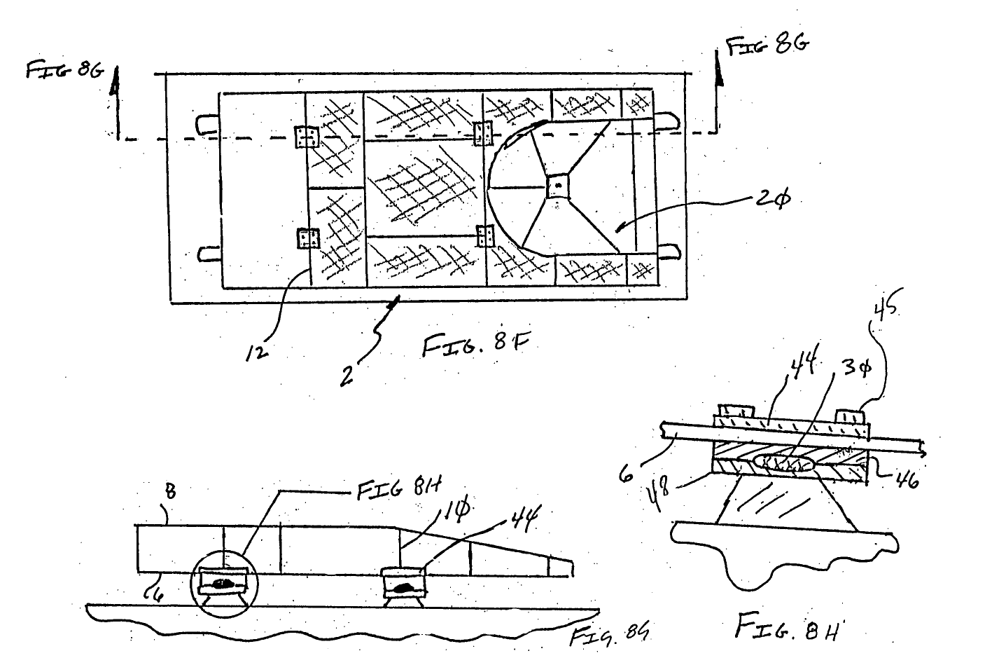

Referring now to FIG. 8, the method of installation of one embodiment of the present invention is shown herein. Generally, SUVs arrive equipped with factory supplied roof structures. These structures are generally made of hollow channels 28 that extend from the front to the rear of the roof. In addition, transverse beams 30 are supplied that extend from one channel 28 to the other, and which span the width of the roof. In one embodiment of the present invention, a plurality of nut plates 32 are supplied that selectively interface with the channels 28 to provide mounting locations for brackets 18 that are interconnected to the lower portion 6 of the rack 2. Installation is achieved by placing the nut plates 32 into the channels 28 of the rack 2 at locations that generally match the spacial relationship between the brackets 18 that are interconnected to the rack 2. Next, the rack 2 is placed atop the existing channels 28 and a series of washers 34 and fasteners 36 are employed to interconnect the bracket 18 onto the nut plates 32. In order to prevent damage to the rack 2 or to the channels 28, to ensure a higher resale value if the rack 2 is removed, rubberized washers 34 are provided in one embodiment of present invention. In addition, in one embodiment of the present invention, a wind deflector 38 is provided in order to alleviate some of the adverse aerodynamic effects the presence that the rack 2 creates during vehicle operation.

Referring now to FIGS. 8F-8H, an alternate attachment method is shown. Many SUVs arrive factory-equipped with roof storage hardware. Generally, this hardware includes a plurality of transverse beams 30 operably interconnected to the roof of an SUV 2 via longitudinal beams, channels, or brackets. Thus, it is desirable to interconnect to the existing structure, thereby alleviating the need to modify the vehicle, and thus insuring a higher resale value. Accordingly, one embodiment of the present invention employs a plurality of transverse beam interface brackets 46 that interconnect with upper brackets 44, which are interconnected to the rack 2. Interconnection of this embodiment of the present invention to the vehicle is achieved preferably by threading fasteners through the upper brackets 44 and the beam interface brackets 46 into a nut plate 48. Alternatively, thru holes may be employed wherein the connection is completed with nuts. The beam interface bracket 46 and the nut plate 48 may be easily tailored to fit a plurality roof or hood structures commonly used on SUVs, trucks, and cars. In addition, a compliant washer, such as a rubber washer, may be included to reduce the chance of transverse beam 30 damage.

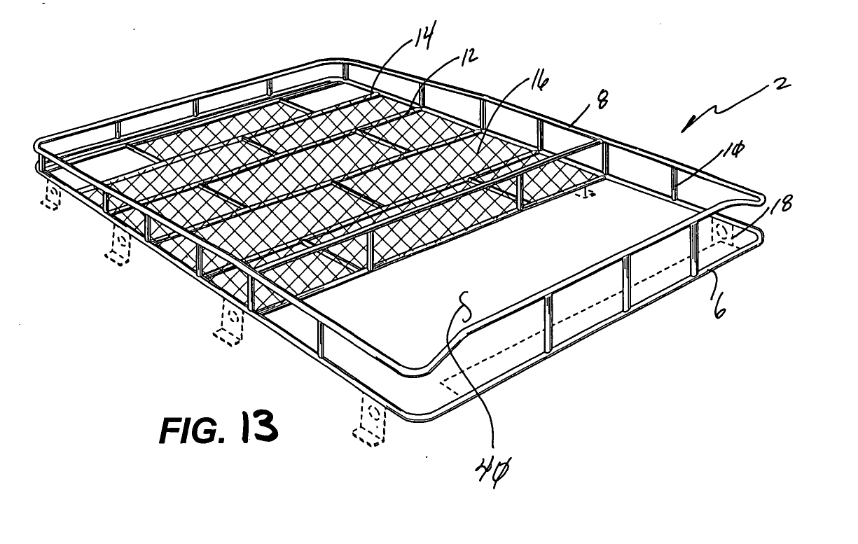

Referring now to FIGS. 9-13, yet another embodiment of the present invention is shown, which omits the tire storage area. This embodiment is very similar to those previously described, however, it omits the tire storage area, which allows for additional storage of luggage or other items. As discussed above, this embodiment consists of a lower structure 6, an upper structure 8, which are separated by vertical members 10, and wherein the lower structure 6 consists of a plurality of transverse members 12 and other support members 14 to define an area wherein mesh 16 may be affixed. Also as shown in FIG. 12, the vertical members 10, in this embodiment, may also be tapered from the front to the back of the vehicle to provide easier access to the roof rack 2. In addition, this embodiment also includes an area where mesh is omitted 40 in order to provide access to a sun roof, however, still allowing for additional storage in the rack 2. For example, a user may still, on occasion, store large items, such as long 2×4s, which may be strapped to the front and the back of the rack 2.

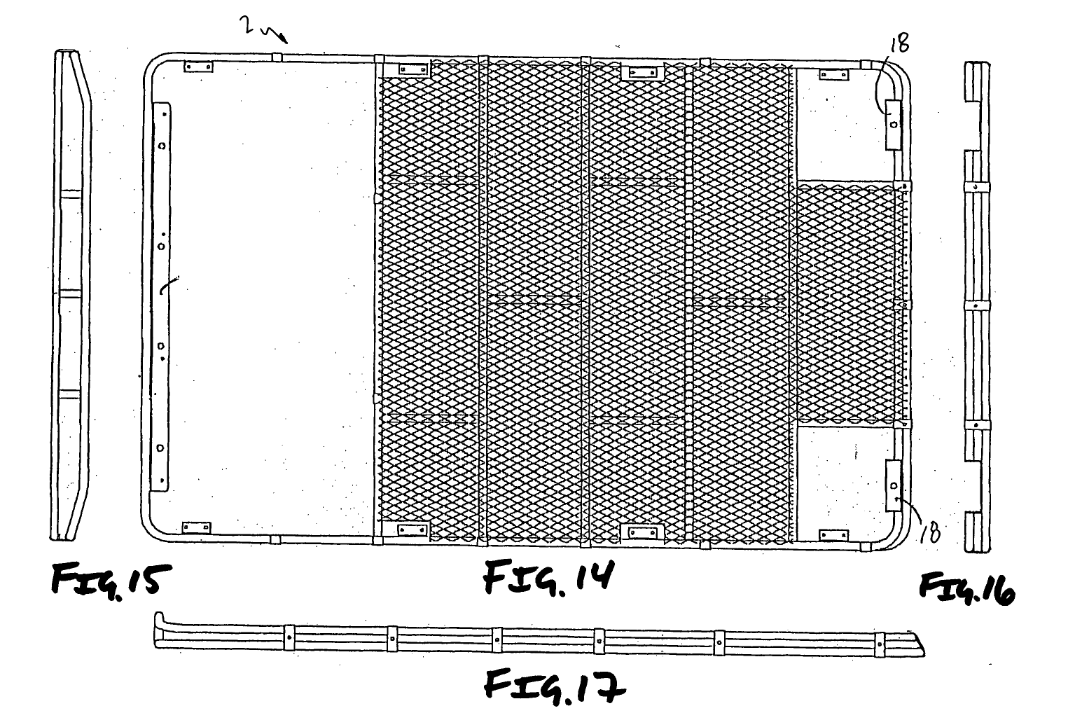

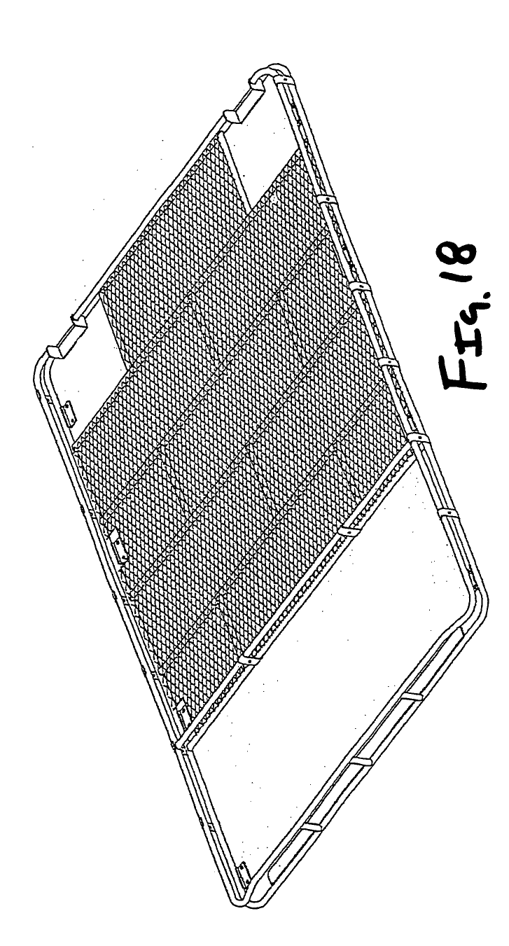

Referring now to FIGS. 14-18, another embodiment of the present invention is shown. This embodiment of the present invention is substantially similar to the previously described rack 2 without a tire storage area. However, as can be seen in a comparison of FIGS. 12 and 17, this rack employs a substantially lower profile, which provides storage area but allows for access into more confined areas. For example, this rack, when installed on a HUMMER®, allows the vehicle to access 84″ garage door openings or standard automatic car washes.

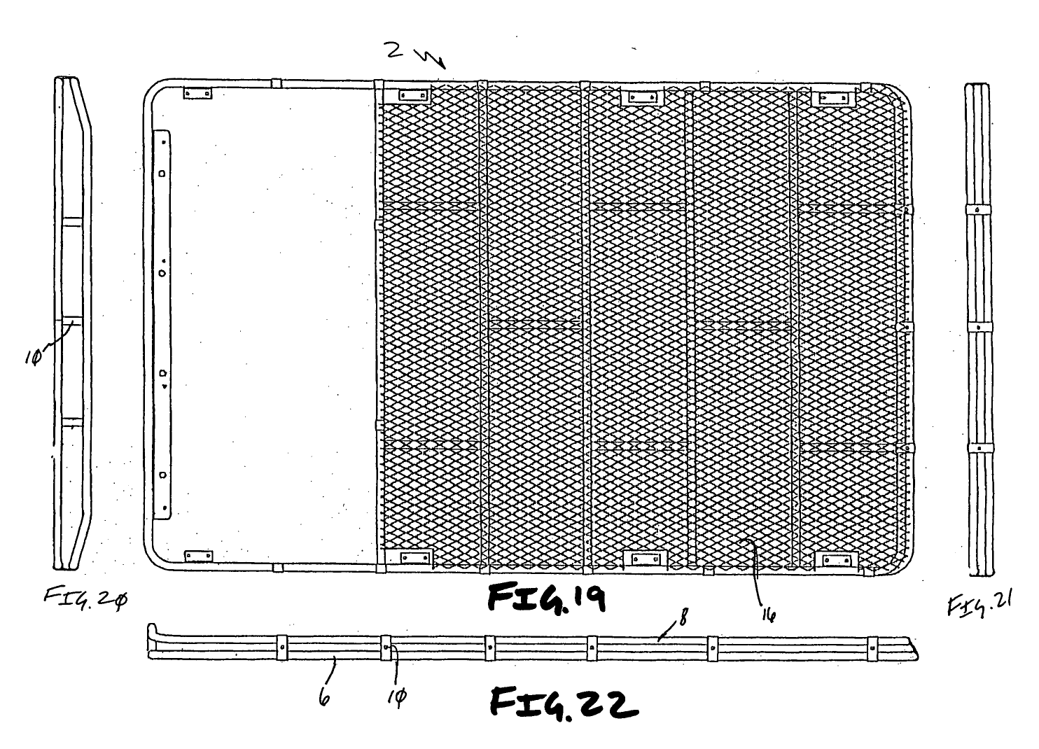

Referring now to FIGS. 19-22, a related embodiment of the present invention is provided. More specifically, this embodiment of the present invention is substantially similar to the one previously described in FIGS. 14-18. However, as can be seen essentially in FIG. 19, a greater portion of the lower support structure 6 is covered with mesh material 16. Although thus far mesh 16 has been described as being a metal material, one skilled in the art will appreciate that any number of materials may be used without departing from the scope of the invention. For example, plastic or rope netting may be tied, or otherwise affixed, to the lower support structure 6 to give the user an option of a wide variety of mesh 16 arrangements. In one embodiment of the present invention, the mesh 16 is wire or otherwise metallic, wherein it is welded, or otherwise affixed, by bolting or screwing to the lower support structure 6. In addition, one skilled in the art will appreciate that this type of mesh 16 and support structure may be incorporated on the upper structure 8 as well to provide another surface wherein articles may be stowed. Finally, mesh 16 or an additional support structure may be integrated onto the vertical support members 10 wherein shelves, or other storage locations, may be provided.

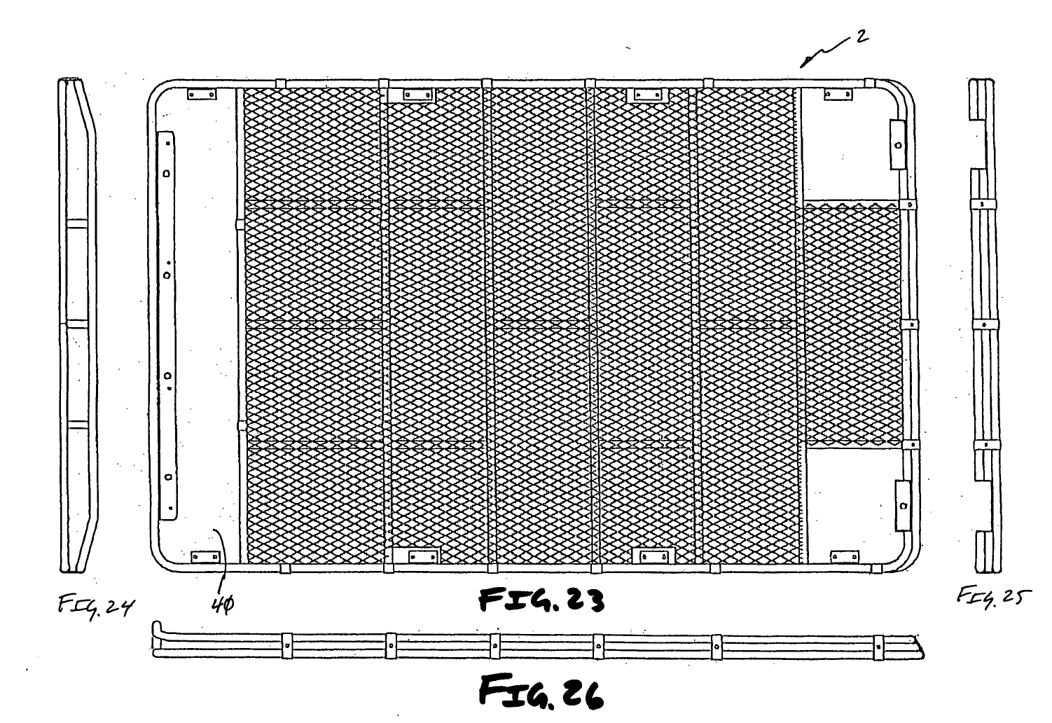

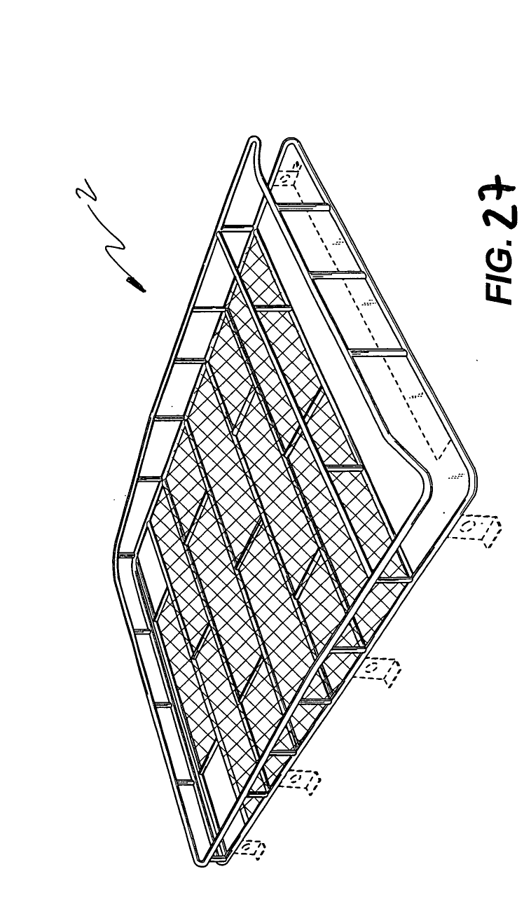

Referring now to FIGS. 23-27, yet another embodiment of the present invention is shown. More specifically, this embodiment shows a smaller area where mesh is not present 40, thereby providing greater storage locations for the user.

Referring now to FIGS. 28-31, another embodiment of the present invention is shown. More specifically, this embodiment is substantially similar to the one previously described in FIGS. 23 through 27, wherein it has a smaller open area 40. However, this embodiment also includes greater meshed 16 areas toward the rear of the rack 2.

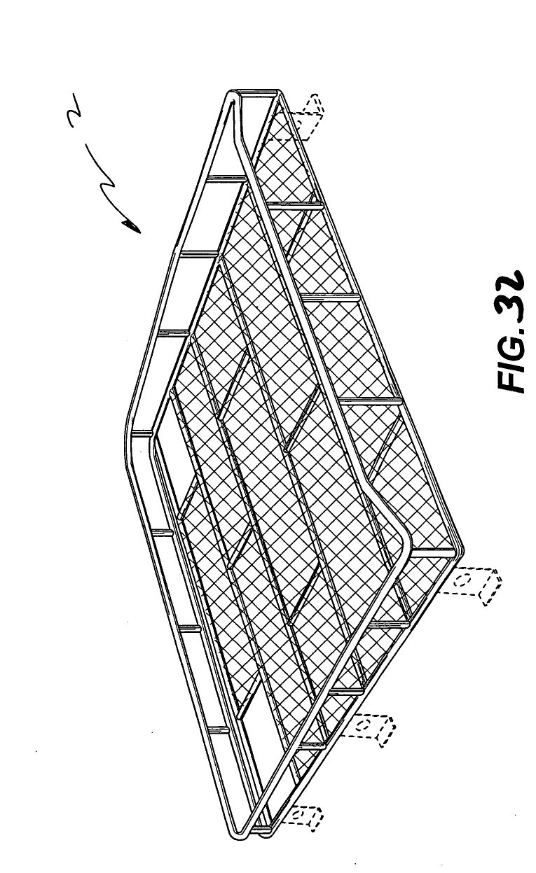

Referring now to FIG. 32, another embodiment of the present invention is shown. More specifically, this embodiment alleviates a portion of the rack. This version of the present invention is shorter, such that no, or substantially little, of the rack 2 is proximate to the sun roof of the vehicle.

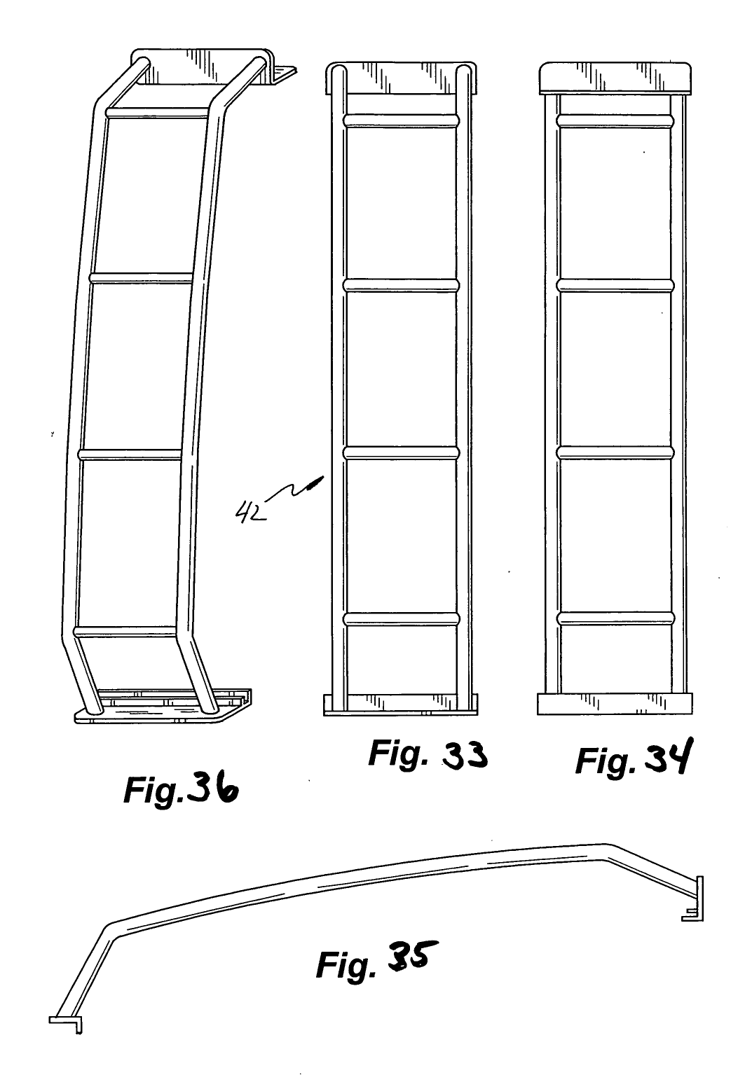

Referring now to FIGS. 33-37, a ladder 42 that may be employed in one embodiment of the present invention, a combination ladder-rack is shown. The present invention is designed to selectively interconnect to the roof of an SUV 4. In order to gain access to the contents of the rack 2 a ladder 42 may be required. This ladder 42 will allow users to access the front portion of the rack 2, that is, the portion nearest to the front windshield of the vehicle 4 by climbing the ladder and traversing the outer boundary, which is defined by the rear edge of the lower 6 and upper 8 support structures. In addition, this ladder 42 may be helpful when selectively interconnecting a tire 22 by providing resting locations during tire elevation. In addition, the ladder 42 will aid in the disconnection of the tire when required, because the user can take advantage of gravity and the ladder 42 to carefully guide the tire down the side of the vehicle 4 without having to bear its entire weight. Furthermore, the ladder is provided with a profile that generally matches the outer shape of the vehicle whereby the contour is, in one embodiment of the invention, pleasing to the eye. Preferably, the ladder is equipped with an upper and lower bracket that is designed to interconnect with the lower edge of the vehicle door 50 via a channel employed thereon. The upper end of the ladder 42 is adapted then to interconnect with the door 50, adjacent to the door hinge 52, via fasteners, hooks, etc., such that the ladder 42 does not interfere with the operation of the door 50. Alternatively, a ladder 42 is provided that selectively interfaces with the rack 2 in a plurality of locations, thereby providing the user various rack 2 access possibilities.

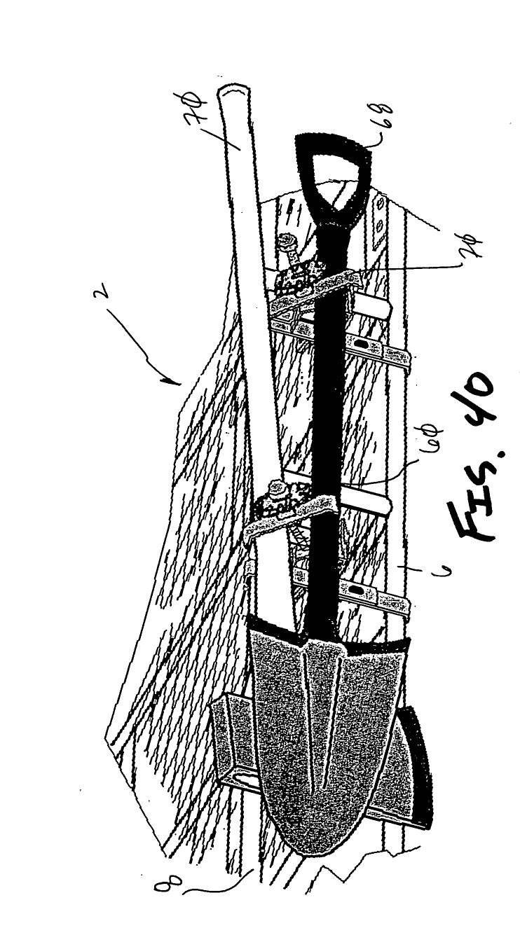

Referring now to FIGS. 38-40, a tool bracket 58 that is adapted for interconnection to the storage rack 2 is shown. More specifically, embodiments of the present invention may receive and secure a tool bracket 58 that interconnects with the lower structure 6 and the upper structure 8 of the support rack 2. A tool retainer 70 is also provided that interconnects to the tool bracket 58 via a screw 72 that is secured to the tool bracket 58 by the turning of a knob 60. Preferably, in one embodiment of the present invention, an axe support 62 and a shovel support 64 are included that provide locations for the storage of an axe 66 and a shovel 68. These tools are secured in place between the axe support 62, shovel support 64, and the tool retainer 70. As one skilled in the art will appreciate many different kinds of tools and may be secured by the tool bracket 58 without departing from the scope of the invention.

While various embodiments of the present invention have been described in detail, it is apparent that modifications and adaptations of those embodiments will occur to those skilled in the art. However, it is to be expressly understood that such modifications and adaptations are within the scope and spirit of the present invention, as set forth in the following claims.

1. A storage rack adapted for interconnection with the roof of a vehicle, comprising:
a lower support structure having a front member and a rear member with two side members positioned therebetween, said rear member also including an arcuate member located between said two side members and extending toward said front member;
an upper support structure of generally the same shape of said lower support structure;
a plurality of vertical members interconnecting said lower support structure to said upper support structure to define a semi-enclosed storage area;
a plurality of transverse members spanning between said two side members of said lower support structure;
a plurality of longitudinal members spanning between at least two of said plurality of transverse members; and
a spare tire support structure interconnected to said lower support structure and bounded by said arcuate member wherein a spare tire may be selectively interconnected to said storage rack such that it rests on said spare tire support structure adjacent to said arcuate member of said lower support structure and said arcuate member of upper support structure, wherein the spare tire may be selectively positioned and removed from said storage rack without lifting the spare tire over said upper support structure.

2. The storage rack of claim 1, wherein said lower support structure further includes a grating material interconnected to said plurality of transverse members and to said plurality of longitudinal members that is adapted to secure small items.

3. The storage rack of claim 1, wherein said lower support structure and said upper support structure are comprised of a metallic tubing material.

4. The storage rack of claim 1, wherein said plurality of vertical members decrease in length between a front portion of said storage rack and a rear portion of said storage rack such that the elevation of said front portion is greater than the elevation of said rear portion.

5. The storage rack of claim 1, wherein said arcuate members of said lower support structure and said upper support structure span at least 180° around said spare tire when it is installed.

6. A storage rack for interconnection with a roof portion of a vehicle, comprising:
a lower support structure with at least one bracket for interconnection with the roof portion of the vehicle;
an upper support structure;
a plurality of vertical support members interconnected to said lower support structure and said upper support structure to define a semi-enclosed storage area; and
a tire storage area integrated into said lower support structure and said upper support structure that is adapted to receive and secure a spare tire, and which employs members that generally match at least a portion of the contour of the spare tire, and wherein said vertical members are positioned in predetermined intervals in order to provide an obstacle-free path for tire interconnection and removal, whereby the tire may be transitioned from said tire storage area to the ground without having to elevate the spare tire over a rear portion of the rack.

7. The storage rack of claim 6, wherein said lower support structure further comprises:
a plurality of transverse members that generally span the width of said storage rack;
a plurality of support members interconnected to said transverse members; and
a grating material interconnected to said plurality of transverse members and to said plurality support members.

8. The storage rack of claim 6, wherein said lower support structure and said upper support structure are constructed of a metallic tubing material.

9. The storage rack of claim 6, wherein said plurality of vertical support members decrease in length between a front portion of said storage rack and a rear portion of said storage rack such that the elevation of said front portion is greater than the elevation of said rear portion.

10. The storage rack of claim 6, wherein said tire storage area further comprises:
a plurality of arcuate members that are integrated into said upper support structure and said lower support structure; and
a plurality of tire support members that are integrated into said lower support structure, and which provide a resting location for the tire and a means to secure the tire.

11. The storage rack of claim 10, wherein said arcuate members enclose at least about 75% of the circumference of the spare tire.

12. The storage rack of claim 6, further comprising:
at least one electrical connector integrated into at least one of said upper structure and said lower structure, said electrical connector being in electrical communication with a power source of the vehicle, wherein said connections are adapted to receive at least one of a light emitting device or a sound emitting device.

13. The storage rack of claim 6, further comprising a wind deflector interconnected proximate to a front portion of the storage rack.

14. The storage rack of claim 6, further comprising a ladder interconnected to said rear portion of said rack and to the vehicle that provides access to said storage rack.

15. The storage rack of claim 7, wherein said grating material is selectively interconnected to said lower portion, wherein the user can selectively alter the grating coverage of said lower support structure.

16. A storage rack adapted for interconnection to a vehicle roof, comprising:
a lower structure, which further includes a transverse member and a longitudinal member,
an upper structure;
a plurality of spaced vertical members interconnecting to said lower structure to said upper structure, thereby defining a semi-enclosed basket;
a tire storage area comprising:
a plurality of lower tire support members for supporting a spare tire interconnected to said lower structure;
a tire securing device selectively interconnected to at least one lower tire support member for engagement with the spare tire;
a plurality of upper tire support members that are spaced from said lower tire support members by a plurality of said vertical members that are spaced to allow an obstruction-free path for tire interconnection and removal; and
a plurality of brackets interconnected to said lower structure which are adapted for interconnection with the vehicle roof.

17. The storage rack of claim 16, further comprising a grating interconnected to said lower structure, thereby providing additional storage locations for smaller dimensioned items.

18. The storage rack of claim 16, wherein said plurality of brackets are adapted for operable interconnection with at least one nut plate that is interconnected to the vehicle roof.

19. The storage rack of claim 16, further comprising at least one electrical connector integrated into at least one of said lower structures, said upper structure, and said plurality of spaced vertical members that are adapted for interconnection to at least one of a light emitting device or sound emitting device.

20. The storage rack of claim 16, further comprising a wind diverting device which is interconnected to a front portion of said rack.

21. A storage rack for interconnection with a roof of a vehicle, comprising:
a lower support structure adapted for interconnection with the roof of the vehicle;
an upper support structure;
a plurality of vertical support members interconnected to said lower support structure and said upper support structure to define a semi-enclosed storage area; and
a cut-out portion integrated into said storage rack which is sized to accommodate an existing tire storage device, wherein said storage rack may be interconnected to the vehicle without interfering with the existing tire storage device.

22. The storage rack of claim 21, wherein said cut-out portion includes members that generally match the contour of a spare tire, and wherein said vertical members are positioned in predetermined intervals in order to provide an obstacle-free path for tire interconnection and removal, whereby the tire may be transitioned from the existing tire storage device to the ground without having to traverse a rear portion of the rack.

23. The storage rack of claim 21, further comprising at least one bracket interconnected to at least one of said lower support structure and said upper support structure that is adapted to secure a tool.

24. The storage rack of claim 23, wherein said tool is at least one of a shovel or an axe.

25. The storage rack of claim 21, further comprising:
a plurality of transverse members that approximately span the width of said roof portion of the vehicle;
a plurality of support members interconnected to said plurality of transverse members; and
a grating material interconnected to said plurality of transverse members and to said plurality of support members, wherein said grating is adapted to secure items to said storage rack.

26. The storage rack of claim 25, wherein said grating material is constructed of at least a plastic, a rubber, a netting, and a metallic material.
